(19) United States
(12) Patent Application Publication
(10) Pub. No.: US 2013/0105375 A1
(43) Pub. Date: May 2, 2013

(54) BALLAST WATER TREATMENT SYSTEM USING A HIGH EFFICIENT ELECTROLYZING APPARATUS

(71) Applicant: AQUA ENG. CO., LTD., Busan (KR)

(72) Inventors: Young-jun Sohn, Busan (KR); Jae-kyung Song, Daejeon (KR); Gwang-hyun Lee, Daejeon (KR); Chung-il Kim, Busan (KR); Yeong-deok Song, Busan (KR); Hwan-koo Lee, Busan (KR)

(73) Assignee: AQUA ENG. CO., LTD., Busan (KR)

(21) Appl. No.: 13/624,714

(22) Filed: Sep. 21, 2012

Related U.S. Application Data
(63) Continuation of application No. PCT/KR2010/009485, filed on Dec. 29, 2010.

(30) Foreign Application Priority Data
Apr. 7, 2010 (KR) 10-2010-0031938

(51) Int. Cl. C02F 1/467

(52) U.S. Cl. CPC C02F 1/4674
USPC 210/192

(57) ABSTRACT

Disclosed is a ballast water treatment system to remove or eradicate various aquatic organisms or microbes remaining ballast water. A water treatment tube manufactured in a filter type is primarily installed to apply physical shock to aquatic organisms having the size of 50 μm or more by modifying the flow of the ballast water to remove or damage aquatic organisms, so that the life power of the aquatic organisms is weakened. Secondarily, a high efficiency electrolysis device employing dual negative electrodes is installed to generate chlorine, so that the remaining aquatic organisms or remaining microbes are completely eradicated. In order to completely eradicate ocean organisms, the ballast water treatment system includes a neutralizing device capable of returning the ballast water to the similar natural sea water by processing remaining chlorine components excessively produced.

### TECHNICAL FIELD

The present invention relates to a ballast water treatment system using a highly efficient electrolysis device capable of removing or eradicating various aquatic organisms and various microbes remaining in ballast water of a ship. More particularly, the present invention relates to a ballast water treatment system using a highly efficient electrolysis device, in which physical shock is applied to aquatic organisms and microbes through a filter-type water treatment tube, chlorine is generated by an electrolysis device employing dual negative electrodes to eradicate the aquatic organisms and microbes, and remaining chlorine is neutralized, so that ballast water is recovered to natural sea water.

### BACKGROUND ART

In general, most ships has a ballast water tank serves as a device to maintain the balance of the ships by collecting and storing the predetermined quantity of sea water for the purpose of maintaining the balance of the ship and safely navigating the ship in the state that the freights are not loaded on the ships. However, ballast water collected for the safety navigation of the ship serves as a medium to carry aquatic organisms and move viruses to break out diseases, thereby mainly causing ocean pollution and the destruction of an ecosystem of other regions.

According to the request of the united nations conference on environment and development in 1992, the international maritime organization has suggested two schemes of replacing ballast water with new one in a predetermined sea before a ship enters a port and physically and chemically sterilize or disinfect loaded ballast water in order to prevent non-indigenous organisms from being spread due to the ballast water and prevent the eco-system from being destructed due to the ballast water.

In addition, if sell fishes or microbes live in a cooling water treating apparatus to collect and use fresh water or sea water or a ballast water treating apparatus related to the safety operation of a ship, heat exchange efficiency may be lowered, a constant flow rate may not be supplied, and a great difficulty may be made in managing facilities. Accordingly, in order to solve the problem, various technologies to dispose the organisms have been developed.

When comparing several treatment apparatuses and schemes, such as a filtering scheme, a UV disinfection scheme, a heating scheme, a chemical treatment scheme, and an electrical treatment scheme, used for the above objects, an electrolysis treatment apparatus represents the greatest effect in terms of economics, safety, and treatment efficiency.

The electrolysis treatment apparatus is used to introduce a predetermined amount of sodium chloride (NaCl) into the fresh water when the electrolysis treatment apparatus is used for the fresh water, and used to generate sodium hypochlorite (NaOCl) from sodium chloride (NaCl) having the content of about 3% in seawater so that the attachment and the propagation of organisms can be prevented by the strong sterilizing power of the sodium hypochlorite (NaOCl) when the electrolysis treatment apparatus is used for the sea water.

Fresh water or sea water treating apparatuses according to the related art are disclosed in Korean Patent Application No. 10-2002-0036086 (filed on Jun. 26, 2002) “Electrolytic sterilizing Arrangements of the Waste Water Disposal Treatment”, Korean Patent Application No. 10-2005-0085605 (filed on Sep. 14, 2005) “SterilizingApparatus for ShipBallast Water Using Electrolysis”, and Korean Unexamined Patent Publication No.10-2006-0113865 (publishedonOct. 14, 2006) “Sterilizing apparatus of ballast water of a ship using double pole type electrolysis system”.

However, as described in Korean Patent Application No. 10-2005-0073408 (filed on Aug. 10, 2005) “An apparatus for monitoring deposits on the electrode of the direct sea water electrolysis system” and Korean Patent Application No. 10-2006-0126694“The Method of electrolysis system for sea-water, freshwater and waste-water using precision switching rectifier”, most of the fresh water or sea water treating apparatuses have problems such as the increase of electrolytic voltage, the damage of an electrode, and the degradation of the electrolysis efficiency as a great amount of magnesium hydroxide (Mg(OH)₂) or calcium hydroxide (Ca(OH)₂) serving as a by-product of electrolysis are attached to an electrode or an electrolysis vessel in electrolysis facilities. However, the ballast water excessively produced may cause damages to ocean organisms living in an area in which the ballast water is discharged.

Therefore, there are required a scheme capable of improving the electrolysis efficiency by minimizing the attachment of foreign matters and a technology capable of minimizing the pollution of the surrounding ocean caused by the excessively produced electrolysis treatment water when operating an electrolysis device of fresh water or sea water used as the ballast water and industrial cooling water.

### DISCLOSURE

### Technical Problem

Accordingly, the present invention has been made keeping in mind the above problems occurring in the prior art, and an object of the present invention is to a ballast water treatment system of a ship using a highly efficient electrolysis device, in which a water treatment tube manufactured in a filter type is primarily installed to apply physical shock to aquatic organisms having the size of 50 μm or more by modifying the flow of the ballast water thereby removing or damaging aquatic organisms, so that the life of the aquatic organisms is weakened. Secondarily, the high efficiency electrolysis device employing dual negative electrodes are installed to generate chlorine, so that the remaining aquatic organisms or remaining microbes can be completely eradicated. In order to completely eradicate ocean organisms, the ballast water treatment system includes a neutralizing device capable of returning the ballast water to water similar to the natural sea water by processing remaining chlorine components excessively produced.

### Technical Solution

In order to accomplish the object of the present invention, there is provided a ballast disinfection processing device which applies the physical shock to microbes having the size of 50 μm or more by primarily utilizing a filter-type water treatment tube, thereby improving the disinfection treatment efficiency of ocean organisms in an electrolysis vessel serving as a secondary treatment device. In addition, an electrode including a plurality of positive electrode plates and a plurality of negative electrode plates is provided in the electrolysis vessel in a direction that electrolytic water flows, so that current can be supplied to the electrode plates through a rectifier (not shown). The negative electrode plates are provided corresponding to the positive electrode plates, in which one negative plate keeps operating, and remaining negative electrode plates alternately remove attached foreign matters so that treatment efficiency can be maximized. Further, before the ballast water of the ship is discharged to the ocean, the ballast water passes through the neutralizing device so that neutralization efficiency of excessively produced chlorine is enhanced, thereby realizing a small-size device and minimize the use of the neutralizing agent to prevent the surrounding ocean from being polluted.

### Advantageous Effect

As described above, in order to treat the ballast water of the ship, the electrolysis vessel and the electrode structure are modified, and a primary treatment step of the ballast water is employed at a front stage of the electrolysis vessel, thereby maximizing the electrolysis efficiency. In addition, the optimal neutralizing device capable of improving the efficiency of the neutralizing agent is provided, thereby preventing the ocean from being polluted and thereby safely disposing the ocean microbes.

### DESCRIPTION OF DRAWINGS

FIG. 1 is a schematic view showing a ballast water treatment system according to the present invention;

FIG. 2 is a schematic view showing a water treatment tube according to the present invention;

FIGS. 3 to 6 are schematic views showing filter-type diaphragms provided in the water treatment tube according to the present invention;

FIGS. 7 and 8 are schematic views showing the arrangement of electrodes of an electrolysis device; and

FIG. 9 is a schematic view showing a neutralizing device to neutralize chlorine remaining in ballast water to be discharged by using a neutralizing agent and to discharge the ballast water.

### BEST MODE

An object of the present invention is to acquire an economical profit by lowering electrolytic voltage, increasing electrolysis efficiency, and enabling the safe operation of a ballast disinfection processing device when producing a material, such as sodium hypochlorite (NaOCl), hypochlorite (HOCl), and ozone (O₃), representing strong oxidativity in order to treat ballast water of a ship. In addition, ocean microbes can be eradicated by treating ballast water, and chlorine, which is excessively produced, is neutralized, so that the ballast water is discharged as similar natural sea water.

In order to accomplish the above object of the present invention, there is provided a ballast water treatment system of a ship, in which a water treatment tube manufactured in a filter type is primarily installed to apply physical shock to aquatic organisms having the size of 50 μm or more by modifying the flow of the ballast water to remove or damage aquatic organisms, so that the life of the aquatic organisms is weakened. Secondarily, a high efficiency electrolysis device employing dual negative electrodes is installed to generate chlorine, so that the remaining aquatic organisms or remaining microbes can be completely eradicated. In order to completely eradicate ocean organisms, the ballast water treatment system includes a neutralizing device capable of returning the ballast water to the similar natural sea water by processing remaining chlorine components excessively produced. The filter-type water treatment tube is installed at the front stage of the electrolysis device, and a plurality of filter-type diaphragms are provided in the filter-type water treatment tube, so that the efficiency of the electrolysis vessel can be improved.

In addition, according to the present invention, in order to improve the efficiency of the electrolysis vessel, positive electrode plates are aligned in line with each other, and a plurality of negative electrode plates are provided corresponding to the positive electrode plates, in which one end portion of each negative electrode plate is narrowed or widened in a longitudinal direction, thereby minimizing the attachment of the foreign matters to the electrode provided in the electrolysis vessel by changing the flow and the flow rate of electrolysis water.

### Mode for Invention

Hereinafter, an exemplary embodiment of the present invention will be described in detail with reference to accompanying drawings. If detailed description of well-known functions or configurations may make the subject matter of the present invention unclear in the following description, the detailed description thereof will be omitted.

A ballast water treatment system according to the present invention includes a filter-type water treatment tube 40, which is installed on an inlet pipe of ballast water to apply the physical shock to aquatic organisms or microbes by changing the flow of the ballast water, thereby killing the aquatic organisms or the microbes or weakening the life of the aquatic organisms or the microbes, an electrolysis vessel 10, which is installed on a pipe provided at the output side of the filter-type water treatment tube 40 and completely eradicates remaining aquatic organisms or remaining microbes by generating chlorine through an electrolysis device for the treatment of ballast water employing dual negative electrodes, and a neutralizing device 50, which neutralizes chlorine remaining in the ballast water, which is discharged from the electrolysis vessel 10 through a ballast tank, by using a neutralizing agent and discharges the ballast water. The filter-type water treatment tube 40 is installed at the front stage of the electrolysis device, and a plurality of filter-type diaphragms 41 are provided in the filter-type water treatment tube 40, so that the efficiency of the electrolysis vessel 10 can be increased.

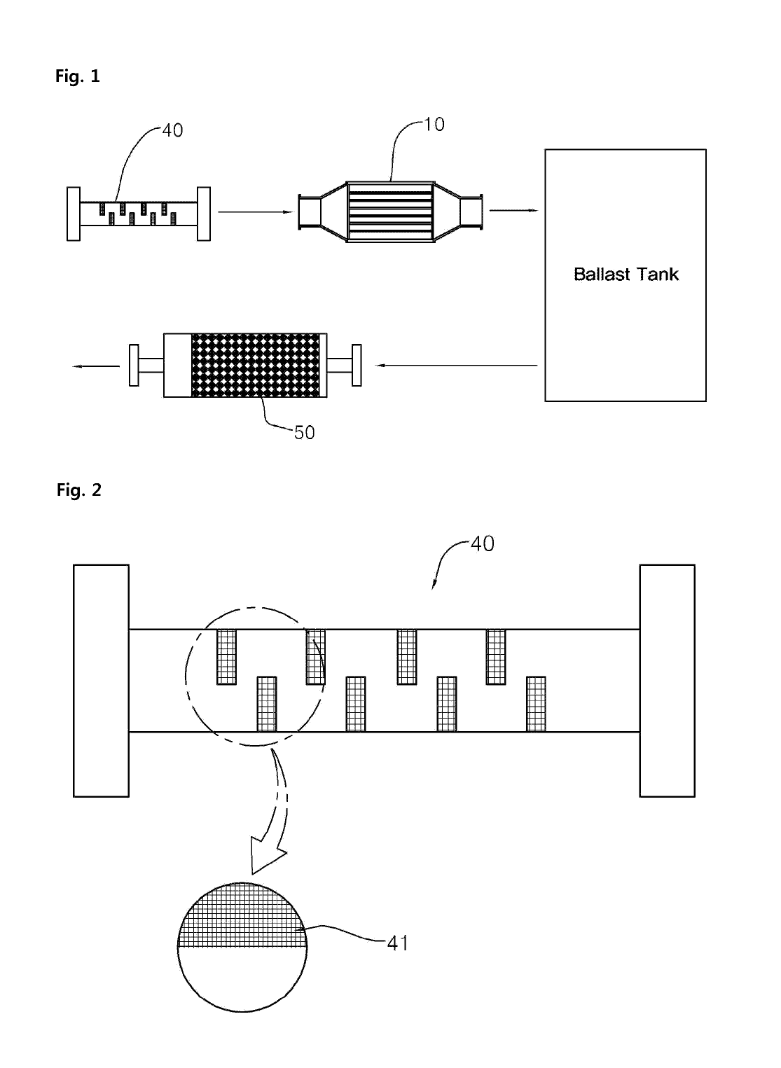

In other words, as shown in FIG. 1, the ballast water treatment system applies the physical shock to the microbes having the size of 50 μm or more by primarily utilizing the filter-type water treatment tube 40 so that a portion of aquatic organisms is eradicated or the life of the aquatic organisms is weakened, thereby improving the treatment efficiency of the electrolysis vessel 10 serving as a disinfection device, and includes the neutralizing device 50, which improves the neutralization efficiency of the remaining chlorine excessively produced in order to eradicate the microbes living in the ballast water of the ship, has a small size, and uses the minimum of neutralizing agents, so that the surrounding ocean can be prevented from being polluted when the ballast water is discharged from the ballast tank. The filter-type water treatment tube 40 is installed at the front stage of the electrolysis device, and the filter-type diaphragms 41 are installed inside the filter-type water treatment tube 40, so that the efficiency of the electrolysis vessel 10 can be increased.

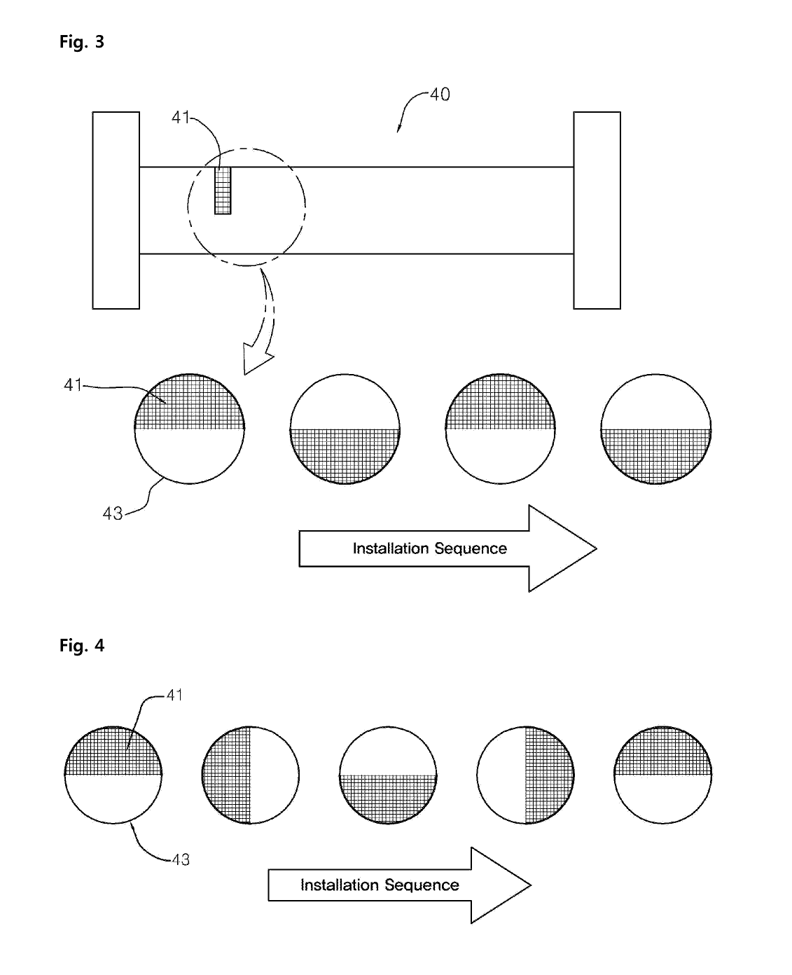

FIG. 2 is a schematic view showing the filter-type water treatment tube 40 used in the ballast water treatment system according to the present invention. A portion or an entire portion of the filter-type water treatment tube 40 is blocked by the diaphragms 41 having the size of 50 μm or less, so that the ocean life having aquatic organisms having the size of 50 μm or more receive physical shock while the influence exerted on the flow of the seawater can be minimized. The pressure difference between the front and rear ends of the filter-type diaphragms 41 can enable the filter-type diaphragms 41 to be automatically cleaned. Each filter-type diaphragm 41 installed in the filter-type water treatment tube 40 has a size in the range of 25 μm or 100 μm.

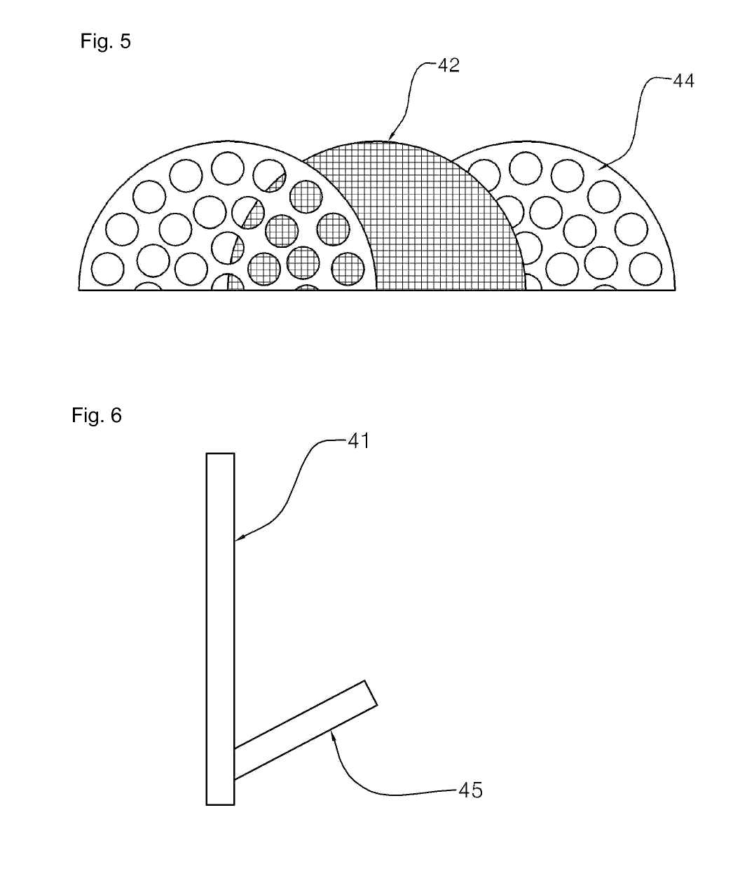

FIGS. 3 and 4 are views showing the structure of the filter-type diaphragm 41 installed in the filter-type water treatment tube. In order to maximize the shock applied to the aquatic organisms having the size of 50 μm or more, the filter-type diaphragms 41, which are provided in the shape of a fan, are alternately installed at the top and the bottom or at the left and the right of the diaphragm support part 43. The filter-type diaphragms 41 of the filter-type water treatment tube 40 has a sectional area corresponding to 30% to 95% of the inner diameter of the filter-type water treatment tube 40 and are installed in the state that the filter-type diaphragms 41 are rotated at an angle of 45 degrees to 180 degrees, so that the flow of the ballast water can be changed.

FIG. 5 is a view showing the detailed structure of the filter-type diaphragms 41 installed in the filter-type water treatment tube 40. Filter support plates 44, which have been bored, are installed at both sides of the filter-type diaphragms 41.

FIG. 6 is a view showing the shape of a baffle 45 to prevent the surface of the filter-type diaphragm 41 from being clogged. When foreign matters are attached to the surface of the filter-type diaphragm 41, water flows back to remove the foreign matters from the surface of the filter-type diaphragm 41 so that the diaphragms 41 can be automatically washed.

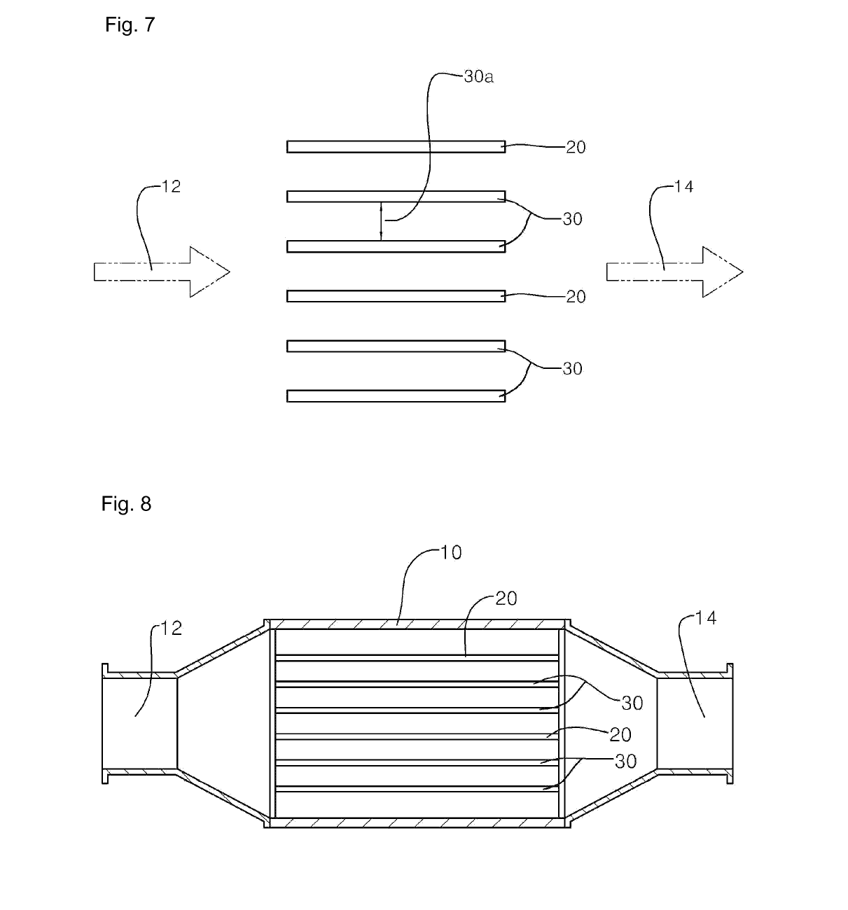

FIGS. 7 and 8 are views showing the ballast water electrolysis device. The electrolysis device includes the electrolysis vessel 10, which is provided at one side thereof with an introduction part 12 and provided at an opposite side thereof with a discharge part 14 so that electrolytic water including fresh water or sea water passes through the electrolysis vessel 10. An electrode including a plurality of positive electrode plates 20 and a plurality of negative electrode plates 30 is provided in the electrolysis vessel 10 in a direction that the electrolytic water flows, so that current can be supplied to the electrode plates through a rectifier (not shown). The negative electrode plates 30 are provided corresponding to the positive electrode plates 20, in which one negative electrode plate 30 keeps operating, and remaining negative electrode plates 30 alternately remove attached foreign matters, so that the electrolysis vessel can operate for a long time.

In addition, when viewed from the plan view, the positive electrode plate 20 and the negative electrode plates 30, which are arranged in a direction that the electrolytic water passing through the inner part of the electrolysis vessel 10 flows, are aligned in line with each other and the sides of both plates are spaced apart from each other by an equal interval 3a while being parallel to each other.

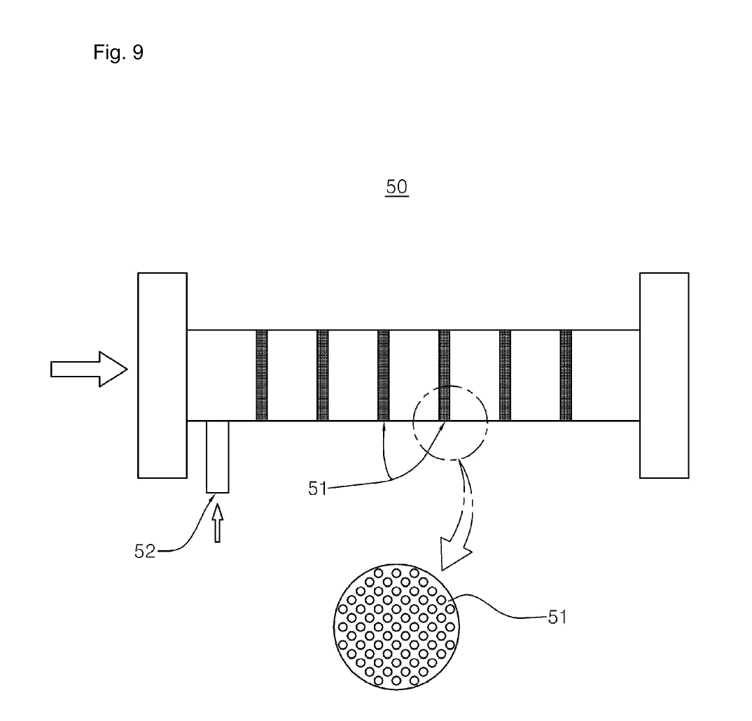

FIG. 9 is a view showing the neutralizing device 50 to neutralize chlorine remaining in the discharged ballast water by using a neutralizing agent and to discharge the ballast water. The neutralizing device 50 is provided therein with a porous diaphragm 51, which is bored, in order to enhance the mixing effect of the neutralizing agent introduced from a neutralizing agent inlet port 52 and the discharged treatment water. The boring ratio of the diaphragm 51 corresponds to at least 50% of the whole area of the diaphragm 51.

Hereinafter, several comparative examples of the ballast water treatment system according to the present invention capable of treating the ballast water of a ship will be described.

### Embodiment 1-3

The ballast water treatment system is provided with a ballast water treatment tube (having a diameter of 2.5 cm, and a length of 25 cm) having a 50 μm filter-type diaphragm and an electrolysis device, which has an internal space with a length of 10 cm, a width of 20 cm, and a height of 10 cm and includes four groups of electrodes, each of which includes a pair of a positive electrode plate and a negative electrode plate, for the disinfection process for the ballast water. In order to neutralize the excessively produced chlorine, the ballast water treatment employs a neutralizing device manufactured with a diameter of 20 cm and a length of 50 cm. The used sea water represents the salinity of 2.9%, and the electrolysis reaction and the neutralization reaction are performed while applying DC current under the condition in which the flow rate is 5 ton/time.

TABLE 1

| | | | remaining | amount of introduced | Efficient of |
|---|---|---|---|---|---|
| | Supply | electrolysis | chlorine | neutralizing agent | neutralizing |
| Embodiment | Current (A) | voltage (V) | (ppm) | (L/min) | agent (%) |
| 1 | 32.1 | 4.10 | 3.7 | 1.2 | 90 |
| 2 | 43.4 | 4.63 | 6.5 | 2.0 | 95 |

TABLE 2

| | elapsed days after | amount of remaining |
|---|---|---|
| Embodiment | treatment | chlorine (ppm) |
| 3 | 0 (the very day of | 6.6 |
| | treatment) | |
| | 1 | 5.4 |
| | 4 | 4.5 |
| | 6 | 4.4 |
| | 11 | 3.0 |

When the electrolysis device provided at the front stage thereof with a filter-type water treatment tube and including a plurality of negative electrode plates corresponding to positive electrode plates is operated, the variation of an amount of chlorine remaining in the disinfected sea water according to the lapse of time is less represented. The increase of the voltage caused by the attachment of the foreign matters can be minimized, so that the disinfection effect of the ballast water can be prolonged, and the efficiency of the electrolysis device can be improved. Therefore, since the variation in the amount of remaining chlorine according to the installation of the filter-type water treatment tube is less represented, an amount of remaining chlorine, which is initially produced to maintain the disinfection effect for a predetermined time, can be reduced, so that the use of the neutralizing agent can be optimized. Accordingly, the neutralizing device can be minimized.

### Embodiment 4-6

A water treatment tube (having a diameter of 2.5 cm and a length of 25 cm) including a 50 μm filter type diaphragm is installed. After the sea water, into which various aquatic organisms (Artemia and Rotofer) having a size of at least 50 μm are introduced, passes through the water treatment tube, living aquatic organisms are checked. About one million aquatic organisms are initially introduced into the seawater, and living aquatic organisms passing through the water treatment tube are checked while varying flow rates of 44 L/min, 63 L/min, and 83 L/min.

TABLE 3

| Embodiment | 4 | 5 | 6 |
|---|---|---|---|
| Flow Rate | 44 L/min | 63 L/min | 83 L/min |
| The number of living organisms | 618,000 | 588,000 | 192,000 |

| | |
|---|---|
| The number of organisms that | 1,050,660 |
| were initially introduced | |

As shown in Table 3, as the flow rate is increased, the efficiency to dispose microbes having the size of 50 μm or more by the water treatment tube can be increased. However, when a filter type diaphragm employing at least 100 μm-filter is installed, the microbes are less removed. When a filter type diaphragm employing an excessively-small filter (25 μm or less) is used, the internal pressure may be increased. In addition, as the size of the section of the filter type diaphragm is increased, the device becomes enlarged. In addition, as the size of the section of the filter type diaphragm is reduced, the effect to remove the microbes may be reduced. In other words, the expected usefulness is represented in the ballast water treatment system employing the filter-type diaphragm 41 of the water treatment tube 40 designed with a sectional area occupying 30% to 95% of a pipe diameter of the water treatment tube based on the effectiveness of disposing microbes.

Although a preferred embodiment of the present invention has been described for illustrative purposes, those skilled in the art will appreciate that various modifications, additions and substitutions are possible, without departing from the scope and spirit of the invention as disclosed in the accompanying claims.

1. A ballast water treatment system using a highly efficient electrolysis device, the ballast water treatment system comprising:
a filter-type water treatment tube (40) installed on an inlet pipe of ballast water to apply physical shock to aquatic organisms or microbes by changing flow of the ballast water, so that the aquatic organisms or the microbes are killed or life power of the aquatic organisms or the microbes are weakened;
an electrolysis vessel (10) installed on a pipe provided at an output side of the filter-type water treatment tube (40) and completely eradicating remaining aquatic organisms or remaining microbes by generating chlorine through an electrolysis device used for treatment of ballast water and employing dual negative electrodes; and
a neutralizing device (50) which neutralizes chlorine remaining in the ballast water, which is discharged from the electrolysis vessel (10) through a ballast tank, by using a neutralizing agent and discharges the ballast water,
wherein the filter-type water treatment tube (40) is installed at a front stage of the electrolysis device, and a plurality of filter-type diaphragms (41) are provided in the filter-type water treatment tube (40), so that efficiency of the electrolysis vessel (10) is increased.

2. The ballast water treatment system of claim 1, wherein each filter-type diaphragm (41) installed in the filter-type water treatment tube (40) has a size in a range of 25 μm or 100 μm.

3. The ballast water treatment system of claim 1, wherein each filter-type diaphragm (41) provided in the filter-type water treatment tube (40) has a sectional area corresponding to 30% to 95% of an inner diameter of the filter-type water treatment tube (40).

4. The ballast water treatment system of claim 1, wherein each filter-type diaphragm (41) provided in the filter-type water treatment tube (40) is installed in a state that the filter-type diaphragm (41) is rotated at an angle of 45 degrees to 180 degrees, so that the flow of the ballast water is changed.

5. The ballast water treatment system of claim 1, wherein filter support plates (44), which have been bored, are installed at both sides of each filter-type diaphragm (41).

6. The ballast water treatment system of claim 5, further comprising a baffle (45) provided at an end portion of each filter support plate (44) to flow water back so that foreign matters are removed from a surface of the filter-type diaphragm (41) when the foreign matters are attached to the surface of the filter-type diaphragm (41).
